(19) United States
(12) Patent Application Publication
(10) Pub. No.: US 2012/0310856 A1
(43) Pub. Date: Dec. 6, 2012

(54) Methods And Systems For Financing And Marketing

(76) Inventor: Hamid Hatami-Hanza, (US)

(21) Appl. No.: 13/484,189

(22) Filed: May 30, 2012

Related U.S. Application Data
(60) Provisional application No. 61/492,347, filed on Jun. 1, 2011.

(51) Int. Cl. G06Q 40/06

(52) U.S. Cl. 705/36 R

(57) ABSTRACT

The present invention provides methods and systems of executing the method/s of financing and/or marketing a venture or product while rewarding the revenue contributing clients of an enterprise based on the stage or the state that they make a revenue contribution to the enterprise. One of the objectives of this invention is to entitle the clients with a reward such as a stock that is appreciable through the growth and success of the enterprise. Such reward “program” is a function of the enterprise market value and the amount of client's revenue contribution at the time of the “revenue contribution event”.

### PRIOR U.S. APPLICATION

This application claims priority from U.S. provisional patent application No. 61/492,347 filed on Jun. 1, 2011, entitled “Methods And Systems For Financing And Marketing” which is incorporated herein by reference.

### FIELD OF INVENTION

This invention generally relates to financing and marketing of ventures, enterprises, security exchange, goods, and services.

### BACKGROUND OF THE INVENTION

Marketing and financing a new and useful venture/good/service is not, often, a trivial undertaking. Conventional capital raising and financing, such as private placements, public offering, bank loans, debentures etc., may not be attractive or viable for many ventures, business entities, and shareholders due to variety of reasons such as time consuming processes, lack of collateral, conflicts of interests, control retaining, paperwork, etc.

Moreover, marketing a venture and/or products/services of an enterprise could or should, in principal, be done in a more efficient and justified fashion than the traditional marketing of goods/service by advertisements, face to face sales, or customer inceptive programs such as air miles rewards, cash back, credit, etc.

Therefore other forms of financing/marketing of a venture/good/service or ways of growing a venture/business/enterprise are desirable.

### SUMMARY OF THE INVENTION

Client and user's have an important role in the success of a business entity. Companies can growth by making a profit from the sale of their good/s and service/s to clients. Therefore clients can be viewed as partners whose contribution toward the success of an enterprise could/should be considered and be rewarded accordingly.

In this invention it is noticed and argued that the impact of a client's revenue contribution to the growth of an enterprise is inversely proportional to the “enterprise market value” of the enterprise. Accordingly, it is an objective of this invention to provide methods and systems of executing the method/s of rewarding the revenue contributing clients of an enterprise based on the growth stage at which they make a revenue contribution to the enterprise.

Moreover, it is another objective of this invention to grant the clients with a reward that is appreciable through the growth and success of the enterprise. Such a reward or “reward program” (or simply the “program”) is a function of enterprise market value and the amount of client's revenue contribution at the time of the “revenue contribution event” (defined in the definition section). Several client's reward “programs” or functions are presented to illustrate the methods and programs. For instance, the reward can be a stock of an enterprise (stock according to the definition given in this invention).

In one preferred embodiment of the invention, the client is rewarded equity in the enterprise as a function of the enterprise market value and the amount of revenue or “revenue equivalent” to the enterprise. Therefore the client's contributions can be treated as a form of investment and the clients can be regarded as partners. In this way the clients are not only retained for repeated business but they would also help to promote sales and marketing for enterprises and therefore fuel the growth of the enterprise with less need from other types of financing options or equity investments.

In another aspect according to the present invention, several exemplary methods, formulation and algorithms for the execution of such methods, programs and functions are given to be selected from by the vendors/enterprise for the client. Two exemplary embodiments of such functions are given in more detail to demonstrate the way a vendor/enterprise chose or select the desired program or on how to design such program with predetermined objectives or goals. The exemplary incentive functions or “programs” are functions of enterprise market value and client revenue contribution or revenue equivalent.

In the exemplary embodiments of such program function/s or granting functions, it is shown that how much dilution an enterprise can expect based on the selected parameters and variables. Also it is shown the stock price appreciation and client's percentage ownership behavior at different stags of the vendor/enterprise versus the cumulated revenue. Different programs/functions yield different results at the time a client is doing business with the enterprise (making revenue contribution). For instance, ownership dilution of the enterprise and the client's ownership percentage versus the cumulated revenue contribution are given for different programs and functions.

According to another aspect of the present invention, the enterprise increases its revenue and gets access to the capital for growth through its clients by giving the clients the incentives to become a client and contribute in increasing the revenue of the enterprise or the venture and therefore its business value in which they have become a stakeholder.

Therefore employing the disclosed “client incentive programs” not only cause to increase the sales but also help to fund an enterprise growth through the revenue generated from the clients in general and early clients in particular.
The advantage of such method/s is that it provide an environment for both enterprise and clients to benefit from the value created from such ventures. The customers not only get the service or the goods but also they benefit significantly from the rapid appreciation of the stock of such enterprises in longer term. In other words, clients enjoy the purchased goods or services while also can potentially get multiple times return on their revenue contribution as the enterprise grows in value as a result of clients' revenue contributions.

So in one aspect of the invention, it provides an incentive for clients to use or subscribe to service/s, enroll in the franchise, purchase the product/s etc, and in another aspect provide rapidly increasing revenue stream to the business so that the business can expand and grow with relaxed needs for outside finances thereby increasing the chances of successful and healthy growth for the enterprise.

The method can be employed readily by online businesses vendors and other service providers. Examples of such vendors are, for example, data providers, telecom service providers, user generated content sites, group buying sites, discount and coupon marketing sites, auction based site, e-trade and e-business sites, social networking services, and/or a knowledge discovery service provider (e.g. search engine, data analytical engine, knowledge farms, etc.).

In another aspect of the present invention, several exemplary systems are introduced for performing the “program” and allocate the reward for the clients of an enterprise using the algorithm and formulations and program details.

Moreover, systems are also given for performing the client's entitlement for a plurality of vendors (e.g. enterprises). Such an intermediate system performs the service of client's stock entitlement for the participating vendors and executes the program/s for the participating vendors and their clients.

Yet in another aspect, a method and system, or a vehicle, is given to provide the service of granting the clients a reward in the form of a security by creating or using an umbrella entity (e.g. an umbrella enterprise) whose stock or security can be used as the stock for rewarding clients of pluralities of enterprises or small business. In this way, several or a cluster of businesses can form a security reward program for themselves using this vehicle without a need of going through legal and administrative efforts of offering such program on their own. This vehicle thus can amplify their growth and revenue while also giving their clients the incentive to contribute revenue to their businesses.

The above system/s are composed of computing devices, storage media, data network interfaces, and software modules so that the selected “program” by the participating enterprise/s can be performed and executed in real time and all the records of entitlements are created and updated in real time for one or more vendor or enterprises.

Moreover a system that perform such a service for more than one participating enterprise is also given so that a central system can offer the service of rewarding “program” to a plurality of vendors or enterprises according to pre-arranged conditions and agreement between the vendors and the service provider of program/s.

Moreover system/s is enabled, through the data communication network, to obtain data related to revenue contribution from the clients of one or more participating vendors. The clients may purchase the good/s or subscribe to the service/s of the enterprise through point of sales terminals, web sites, mobile terminals and devices and the like to perform a purchase or contribute a revenue equivalent value to the participating vendors.

Nowadays it has become easier for enterprises to be listed in public markets and therefore many enterprises can enjoy the program. So in one of the embodiments of this invention the method and “program” can be used in conjunction with other services of public stock trading markets as another way to finance and/or market an enterprise's goods or services and fuel the enterprise's growth internally by way of generating more revenues.

Accordingly, yet in another aspect, methods and system are given for rewarding the clients of vendors or enterprises with publicly traded securities of their own or securities of other enterprise with the selected predetermined “program’ and the corresponding algorithms.

The disclosed methods and systems of the present invention help to increase the enterprise market value by generating more revenue and providing the finances or the funds for the growth of the enterprises. The methods and the systems therefore increase the chances of success of the business entities significantly, particularly for early stage ventures. Moreover, the costumers get their reward through the appreciation of enterprise market value in which they have participated in their reward program through making revenue contribution. The method and the associated system/s are intrinsically different from revenue sharing, commissioning and network marketing.

Furthermore, the clients are encouraged to do further marketing for the business entity through word of mouth or peer recommendation to other businesses so that the marketing expenses for the business can be dramatically reduced. Also since the clients/costumers have a direct interest in the business (or the venture) they provide much better opinionated feedback for enhancement of the products and services of the business entity.

The net result is a positive feedback loop that customers and enterprises both can benefit from rapid growth of the business and in general providing a higher economical growth by providing a supporting networking environment between pluralities of vendors and clients through cross-ownerships and revenue contributions to each other.

### BRIEF DESCRIPTION OF THE DRAWINGS

FIG. 1: shows conceptually the method of marketing and financing according to the present invention.

FIGS. 2A and 2B: exemplary graphs showing the market value of the enterprise versus the normalized cumulated revenue contribution for two exemplary choices of function f in Eq. 1.

FIGS. 3A and 3B: enterprise share dilutions percentage versus the normalized cumulated revenue contribution corresponded to FIGS. 2A and 2B, respectively.

FIGS. 4A and 4B: cumulative number of shares (normalized versus the initial number of shares) versus the normalized cumulated revenue contribution, corresponded to FIGS. 2A and 2B, respectively.

FIGS. 5A and 5B: semi-log plot of client's percentage equity change after one unit revenue contributing event versus the normalized cumulated revenue contribution corresponded to FIGS. 2A and 2B, respectively.

FIGS. 6A and 6B: share price (normalized versus the initial share price) versus the normalized cumulated revenue contribution corresponded to FIGS. 2A and 2B, respectively.

FIGS. 7A and 7B: share price (normalized versus the initial share price) versus the unit revenue contributing event's number corresponded to FIGS. 2A and 2B respectively (insets are showing the concept of appreciation gain for the ith client's unit revenue contribution at the jth unit revenue contribution event, AGᵢ(t=j).)

FIG. 8A: a flowchart showing the process of vendor/enterprise participation, program selection, and implementation according to an exemplary embodiment of the invention.

FIG. 8B: shows an exemplary system providing the service of accepting vendors or enterprises to participate in the method/program, offer their stock for being listed on the service, and performs the process and algorithms of FIG. 8A for a plurality of participating vendors and their clients.

FIG. 9A: a flowchart showing one exemplary process of implementing the “program” for one or more participating vendor under an umbrella enterprise.

FIG. 9B: shows an exemplary system that performs the process and algorithms of FIG. 9A for a plurality of participating vendors and their clients through an umbrella enterprise.

FIG. 10A: an exemplary system of providing the service of FIGS. 9A, 10B, 11, and 12, showing one way of implementing and performing the method/s and providing the service/s to vendors and clients through the data network and devices.

FIG. 10B: an online service provider providing a service (stock assignment to the clients and share trading) for a plurality of vendors/enterprises/clients, according to the method and algorithms of the present invention, wherein conceptually depicts the cross-ownership network of vendors and clients with each other.

FIG. 11, an exemplary flowchart of one method embodiment of client stockholding program according to the present invention, wherein the client becomes a stock holder and the vendor buys the stock for its client as the stock price is determined through public market where the stock is being listed.

FIG. 12, The system that provide a service for plurality of vendors (enterprise, companies) who want to participate in the client stockholding reward program.

### DETAILED DESCRIPTION

Some of the terms are defined herein for better clarification in the description as the followings:

1. Enterprise: a legal entity for doing for profit or non-profit business such as firms, corporations, companies, partnerships, limited partnerships, sol-proprietorship, non-profit organizations, etc.

2. Client: refers to those entities contributing revenue or value to the enterprise by way of buying one or more good and/or using and/or subscribing to one or more services of an enterprise. Herein it also may refer to any type of user of one or more services of an enterprise such as visitors of a webpage, e-business, or social networks, content farms, search engines etc. Those clients who contribute value could be those who provide a service such as providing content, giving feedback, advice, consulting service, enrolling in a website, introducing new clients and the like and/or anything deemed valuable for or by the enterprise and even may include the value/s that contributed by the employee/s of the enterprise. A customer or a client therefore can be a person, a business entity, an enterprise, for profit or non-profit organizations, or any combinations thereof.

3. Revenue Contributing Event (RCE): an event that is defined by the enterprise and/or one or more client's of the enterprise. The RCE event is generally a function of time and the amount of revenue contributed by a client. In general RCE is a predefined agreement that is defined by the enterprise and/or the client. The minimum required revenue that triggers the event can be arbitrary small.

4. Value Contributing Event (VCE): an event that a client provide a deemed valuable contribution to the enterprise. The minimum required value that triggers the event can be arbitrary small. The VCE can be translated to RCE (Revenue Contributing Event) with predetermined conversions formula/s that is set by the enterprise and/or by the client/s from time to time. Therefore we deal with VCE in the same manner as RCE conceptually and in the description we most often use RCE to explain the methods, algorithms, and the systems.

5. Stock: means any type of redeemable objects or financial products such as coupons, credit points, air miles, cash back etc, and/or any type of security such as common or preferred shares of an enterprise and/or any other derivatives such as options, future, swap, warrants, and/or generally anything that qualifies as security or redeemable and/or tradable and/or exchangeable, tangible or otherwise.

6. Share: refers to the shares of a company or corporation or enterprise or any business entity.

7. Enterprise market value (EMV): EMV is the market value of an enterprise that is either set by the enterprise and/or one or more clients of the enterprise, or one or more investors in the enterprise by way of paying to purchase the stock of the enterprise and/or is determined by a public market such as a stock exchange market.

8. Program: refers to allocating or authorizing certain type/s of stock (as defined above) with a plan and/or entitlement calculation function/s and/or assignment formula/s and/or distribution procedure/s and/or period/s and/or amount/s for awarding or granting them to the revenue or value contributing clients.

9. Exchange system: is a system or organization that can provide the service of trading and exchanging the stocks to the buyers and sellers of the stocks and more specifically it could be an electronic system of trading stock providing the service for stock brokers to trade stock, bonds, and other securities such as stock exchanges and stock markets.

These definitions are minimum coverage for the meaning used here and should not be considered as restrictive to these definition, any other referenced meaning not conflicting with these definitions which is norm or known in the related arts and domains will be considered acceptable as part of the definitions of the terms above.

In what follows the inventions and the drawings are described in more details.

It is noticed that in reality most of the value of an enterprise is accounted for the paying clients that not only fuel the growth but also help to build the brand capital for an enterprise. Therefore the clients and especially early adaptors have a significant role in growth of a company and its market value.

The ventures can usually grow organically by the steady increase of the revenue from the clients and operating with positive cash flow. However in today's world of fast pace changing that might take a while or need significant marketing efforts and expenses which might results in failure or death of an otherwise a useful and important venture. Therefore other ways of obtaining and retaining customers to increase the revenue is desirable to accelerate the organic growth of an enterprise and having access to the capital.

For instance, in this age of internet connectivity, many established and startup businesses migrating their business to the internet and cloud environments. A critical factor in success of these lines of businesses are the number of clients that one venture can capture in the early stage of its launch in order to establish a brand presence. The market value of online business often is highly correlated to the number of customers and the revenue they can generate.

Marketing expenses of such ventures often becomes a barrier to entry for the new ventures. Many worthwhile and useful ventures are failed because of lack of resource in the marketing arena or attracting and retaining clients at the early stages or even at later stages to stay competitive. Therefore, marketing expenses for launching a new venture or a product/service can often be a great barrier to an otherwise useful and important venture or product and/or service.

Moreover, many entrepreneurs prefer to avoid raising the capital needed for the launch or expansion of their ventures through institutional investors. Public offering of securities of the enterprise may also not be viable or an attractive option at the time, e.g. the early stages of ventures. Nevertheless, in reality the ventures need significant capital to fund its growth and marketing expenses.

Therefore clients/users are important part of any enterprise and they can be regarded as contributing in building the business of an enterprise. Hence, it would be fair to regard and treat them as partners and reward them accordingly in a form a partner would be benefited from the success of an enterprise. Such reward might be in the form of equity value appreciation, dividend, or generally any form of benefits that a business partner or a partial owner of a business or an enterprise would enjoy. Additionally it is not only fair to reward the clients but also it is a good gesture from the enterprise to do so, so that to retain the clients' loyalty. Moreover it would be an effective marketing tool to attract more clients and retain them as well.

However the impact of a client's contribution very much depends on the stage or the state that a client does business with an enterprise. For instance early adaptors and early contributor of a new venture are more critical than the later stage clients. Therefore customers and especially early clients of a venture have a role in the success of a business and particularly in the online businesses world. Considering another instance in which an enterprise might be in a financial difficulty and perhaps its “enterprise market value” (EMV) has been dropped significantly. In this case the contribution of paying clients are more important than when the enterprise is doing well and have a high EMV.

Consequently, the reward for a client should be somehow proportional to the stage or the market value of the enterprise at the time of doing business with a client.

Accordingly it is an objective of this invention to provide methods and systems of executing the method/s of rewarding the revenue contributing clients of an enterprise based on the stage that they make a revenue contribution to the enterprise. Therefore it is an objective of this invention to grant the clients with a reward such as a stock (stock according to the definition given in this invention) that is appreciable through the growth and success of the enterprise. Such a reward or reward “program” is a function of enterprise market value and the amount of client's revenue contribution at the time of the “revenue contribution event” (defined in the definition section).

In this invention the reward is in the form of an entitlement to an enterprise's stock (could be the stock of the same enterprise) at a certain value which is set by the stage that a client pays for the enterprise service or goods or contribute values to the enterprise. Obviously the service or the goods should be valuable to the client and this method is for rewarding the clients and specially the early clients. In some occasions the business of the enterprise is partially carried out by the outside contributors. Such business, for instance, might deal with or use user generated content or distant contractors, consultants, mentors, teachers, composers, artists, etc.

As the company generates and increases its revenue so is the “enterprise market value” and consequently the value of the clients equity in the enterprise. The equity can be cashed out by the client in the public or private equity market. This method is different from usual rewards to the clients by the retailers in the forms of points, air miles, coupon, or cash back. These rewards are almost constant and do not appreciate in value over the time.

In this way not only the clients enjoy the benefit of the service and the products of the enterprise but also will financially benefit from the appreciating value of the enterprise. Furthermore the clients are encouraged to help marketing the products and services of the enterprise without extra marketing efforts from the enterprise. Additionally such clients are more likely to give feedback to the enterprise voluntarily as how to improve the products and services since they have a stake in the venture.

As a particular example, the enterprise could be a knowledge discovery service provider that provides service to its clients by helping them to gain and discover credible and substantial knowledge related to their subject matters of interest/s. In this instance, the enterprise and the clients, that are using or subscribing to the service and either pay for the service or otherwise contribute to the knowledge discovery system, which deemed valuable for the enterprise, are good examples of employing the method of the present invention or the disclosed client reward “program”.

In another such exemplary instance, a client or a user subscribes to the knowledge discovery and publication system to publish contents on online journals or other media. In this case the clients' base of such system could be the authors, the editors, and publishers of e-contents that with or without the use of service/s of the enterprise would like to obtain or compose high value contents. In this case there could be a revenue sharing arrangement between the composer/s, editor/s and the enterprise yet the revenue contributing parties (e.g. composer, editor, etc) also will further be rewarded by becoming a stakeholder of the enterprise that they have had a contribution.

With this introduction, the description is now further continued by explaining the marketing and financing methods and systems disclosed in this invention in reference to the exemplary and conceptual embodiments.

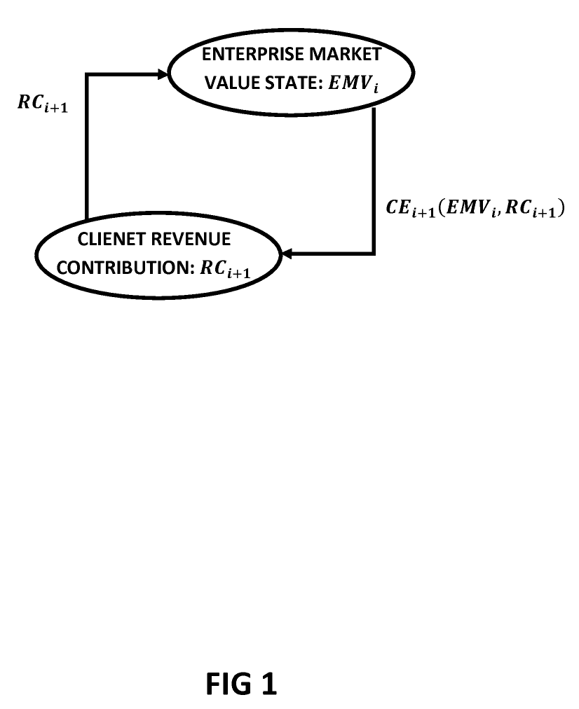

Referring to FIG. 1 here, it shows the concept of marketing incentive or the reward “program” with revenue generation/financing according the present invention. An enterprise market value state will change (usually increases) as a result of a revenue contribution from a client. Consequently the sate of the “Client's Equity” (CE) in the enterprise will change and usually increases in value.

Assuming we have an enterprise that have an “Enterprise Market Value” of “EMVᵢ” at the time that client number i+1 is doing a business transaction (e.g. a “revenue contributing event” is triggered) and, for instance, a client subscribes to a service or buys a product from the enterprise. After such transaction, the value state of the enterprise will be changed wherein the value of the enterprise change (e.g. increases) to a new state EMVᵢ₊₁, that can be given by:

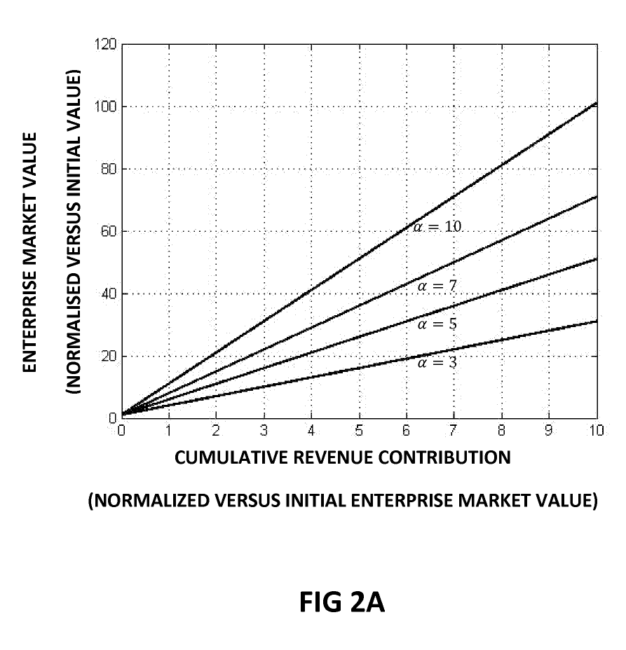

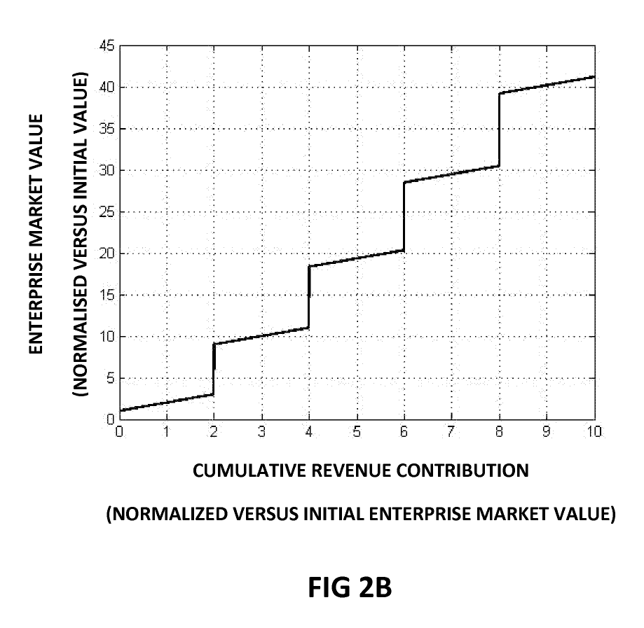

EMVᵢ₊₁=EMVᵢ+f(RCᵢ₊₁,EMVᵢ), . . . i=0, 1, 2, 3, . . . (1)

wherein RCᵢ₊₁ is the “Revenue Contribution” from the client number i+1 and f is a predetermined function. For instance and for the sake of simplicity and, according to one embodiment of the present invention, f can be a linear and/or a stepwise function versus the “Revenue Contribution” or versus, for even more simplification, the normalized cumulative revenue as shown in FIG. 2A or 2B. The function f might also, for instance, be a linear or stepwise function of EMV or any other related variables or parameters (e.g. stock price) that either RC or EMVᵢ are a function of, etc.

To prevent unnecessary mathematical complications (e.g. running into partial deferential equations, continues differential calculus, variational calculus etc.) and easier grasp of the concept, idea, and the presented solutions in this invention, we only describe the invention and the exemplary embodiments in the form of discrete events. Alternative formulations, e.g. continues event formulations and/or general or/and specific case formulations, can be readily done by those skilled in the art without departing from the spirit and the scope of this invention.

The unit for enterprise market value is usually a monetary currency. However, the enterprise market value can have unit of any other measurable and useful quantity like, for example, a Joule (i.e. the well known unit of energy or work) for that matter.

After a client (say the ith client) pays for the service or the goods and provide RCᵢ, ith “Revenue Contribution” amount of revenue to the enterprise, the client is entitled to the ownership of a number of stock or shares (SNᵢ) in the enterprise which would be a function of the revenue of that client at the most recent transaction and the stock/share price (or the enterprise market value, see Eq. 3) at or after the time of transaction, which can be given by:

SNᵢ=g(RCᵢ/SPᵢ) (2)

wherein g is a predetermined function, which for practical uses can be a liner function with a constant slop such as 1, and SNᵢ is the number of shares that the ith client is entitled by having generated RCᵢ amount of revenue for the enterprise and SPᵢ is the stock/share price of the enterprise immediately after the transaction (i.e. after the time that the client pays for the service or goods). The SPᵢ is given by:

$${SP}_{i} = \frac{{EMV}_{i}}{{CSN}_{i - 1}} , … i = 1 , 2 , 3 … \qquad ( 3 )$$

wherein the CSNᵢ₋₁ is the cumulative number of stocks/shares of the enterprise before the revenue or revenue equivalent coming from the ith client. The CSNᵢ₋₁ can be calculated as:

CSNᵢ₋ᵢ=CSN₀+Σₖ₌₁ⁱ⁻¹, i=2, 3, . . . (4).

In the above equation the CSN₀ is the initial stock/share number which is a predetermined number and in fact is related to the initial (e.g. at the time zero) predetermined value of the enterprise EMV₀. Accordingly the initial share price before the execution of the “program” is 51³₀ which is determined by:

SP₀=EMV₀/CSN₀ (5)

Moreover, the “Client Percentage Equity” increases immediately after revenue generating transaction (the ith revenue generating event) wherein the change can be calculated by:

$$Δ C P {E}_{i} ( in \% ) = 100 \times \frac{{SN}_{i}}{{CSN}_{i}} \% \qquad ( 6 )$$

wherein the ΔCPEᵢ is the change (usually a positive value) in the “client percentage equity” in the enterprise immediately after the ith “revenue contributing event”.

Another variable of interest can be defined as the “Appreciation Gain”, AGᵢ for the ith client at the time of the jth “revenue contributing event” which can be given by:

$${AG}_{i} ( t = j ) = \frac{{SP}_{j}}{{SP}_{i}} , … i = 1 , 2 , 3 … and j \geq i \qquad ( 7 )$$

wherein AGᵢ(t=j) is the “appreciation gain” in the share price at the time of jth “revenue generation event” and SPᵢ is the share price at the time of ith client transaction and SPⱼ is the share price for the jth client who has caused a transaction or triggered a “revenue contributing event”. Similarly the enterprise would be interested to know how much share dilution will occur after certain amount of revenue being generated through this program. Therefore one may define a parameter indicating “Enterprise Share Dilution Percentage” (ESDP) in the ith state as:

$$E S D {P}_{i} ( in \% ) = 100 \times \frac{{CSN}_{0}}{{CSN}_{i}} \% \qquad ( 8 )$$

Eq. 1 to Eq. 8 are to lay the foundation of the mathematical models of the methods to be used by the associated algorithms for implementation and execution of the method/s and the program/s. Any other useful and alternative definitions or formulation can be used or given by those ordinary skills in the art of without departing from the spirit and scope of this invention. The above definitions, functions, and quantities are for illustrations and exemplifying the concept in practice and how such programs and method of financing and marketing may be exercised in practice. Accordingly the examples and definitions and formulation given here are one way of formulating the concept, the idea, and the methods of this invention and should not be considered as restriction or restrictive for the method.

Consequently, if one wants to consider the revenue contribution to the enterprise as an investment, one can calculate other derivative variables and parameters of interests such as price per earning, capital gain, return on investment etc. Many other parameters can be derived from this basic formulation and the description of the financing and marketing method of this invention.

It is further understood that the above formulations can be altered depending upon the predetermined arrangements, for instance the share price for the ith client can be considered the share price immediately before the ith client's transaction is completed whereas, in this exemplary offering case, we considered the share price after the ith client's transaction is completed. Also the functions off and g in Eq. 1 and Eq. 2, can be defined based on the needs, objectives, and/or the prearranged offering schemes of the enterprise.

Such an ownership could be arranged in the form of variety of legal instruments, vehicles, and agreements such as debenture (ordinary or convertible), option, swap, coupons, cash back, credit, share allocation, treasury stock, or in general any type of security instrument that can be treated as an investment etc.

When the enterprise is a private corporation the agreement could be in the form of recording the ownership of each clients or revenue contributing party. The stockholder therefore can be benefitted from the dividends or the stock price appreciation or both. Moreover it can include the promise of going public and the stock become tradable in the public market. Sometime, for variety of legal reasons, e.g. financial security laws, the enterprise's stock should be declared public and should or can be offered in a public as soon as it become necessary. Alternatively the client's entitled stock can be recorded in the form of a stock option which can be vested over a certain period of time or being bought for the client from a treasury stock which might have been pre-allocated for this program.

The rational clients will not buy the goods or services if they do not need the product or service since the ownership at the time of purchasing the goods or services does not provide enough incentive for the clients to buy the product or the services that the client does not need solely for becoming a stockholder of an enterprise that offer such program. On the other hand when clients buy a good or service that they need then they can also enjoy the benefits and appreciation of the stock ownership as a result of their purchases.

For the retail clients of small goods there could be some minimum amount of purchase or accumulated purchases that entitle its clients to enjoy the program.

However nowadays it has become easier for enterprises to be listed in public markets and therefore many enterprises can employ the program. So in one of the embodiments of this invention the method and “program” can be used in conjunction with other services of public stock trading markets as another way to finance and/or market an enterprise's goods or services and fuel the enterprise's growth internally by way of generating more revenues. Therefore such method can readily be exercised by variety of enterprises. For instance, in yet another embodiment, the reward program still can work by awarding a customer the stock of another publicly trading enterprise.

In the case that the enterprise is already a publicly traded entity, the value of enterprise for each client at the time of transaction can be considered the enterprise market value in the public market.

Therefore accordingly all types of small and large, startups, and new corners as well as large corporations, retails, service providers, transportation enterprises, utility providers, telecom, data and content providers, etc can readily adapt the program.

According to one of the embodiments of present invention, a cluster of small businesses can use an umbrella enterprise to offer the reward program (i.e. ownership program) to their clients through the umbrella enterprise. Furthermore, the participating small businesses or the participating vendors can be regarded as a client to the umbrella enterprise and earn their entitled stock from the umbrella company based on the amount of revenue that they generate for the umbrella company. The participating vendors might also be the founders or the original shareholders of the umbrella enterprise.

Therefore the program, the methods, and the associated systems, algorithms and the computer readable and executable software can be utilized in variety of situations and by variety of enterprises.

In order to illustrate the method/s and algorithms disclosed in this invention further, typical behaviors of the enterprise market value (EMV), client equity percentage, appreciation gain and other parameters are now given by way of exemplary scenarios and functions so as to show both the enterprise and the client benefits and gains.

We consider two exemplary choices of functions for the function f and a simple choice for the function g to demonstrate an exemplary implementation of the method/s and its implication based on these choices.

In the first exemplary embodiment we might select the following function:

f₁(RCᵢ₊₁,EVᵢ)=αRCᵢ₊₁ (9.1)

wherein f₁ is just one choice of function and α is a constant parameter such as 1, 2, 3, etc. or can be a function of other variables such as being a function of enterprise market value (i.e. α(EMVᵢ) (see FIG. 2A). In this exemplary case, when α is a constant, a linear relationship between the appreciation of enterprise market value and the revenue contribution is achieved. Accordingly the choice of the parameter α in Eq. 9.1 determines how aggressively the enterprise market value would increase for each “revenue contributing event”. The choice of α can usually be related to the gross margin or the marginal revenue of selling each service or good which can be different from business to business. As a rule of thump the higher the net profit gained from each sell or the “revenue contributing event” the higher the α can be as signed.

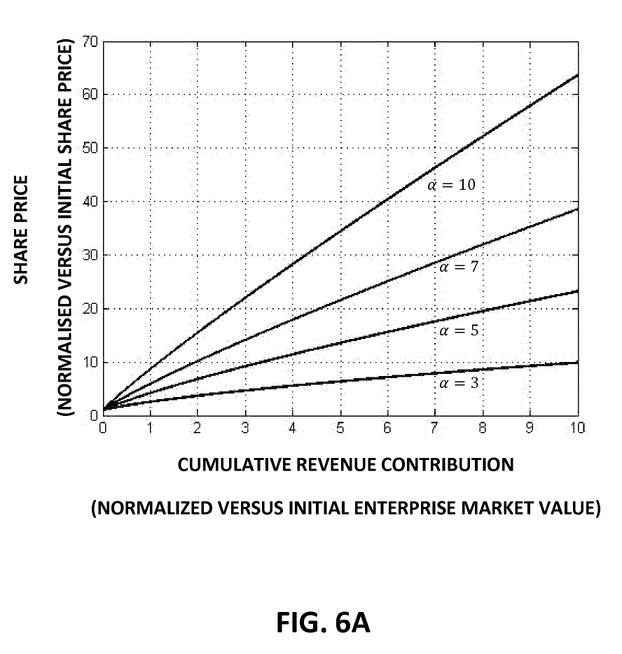

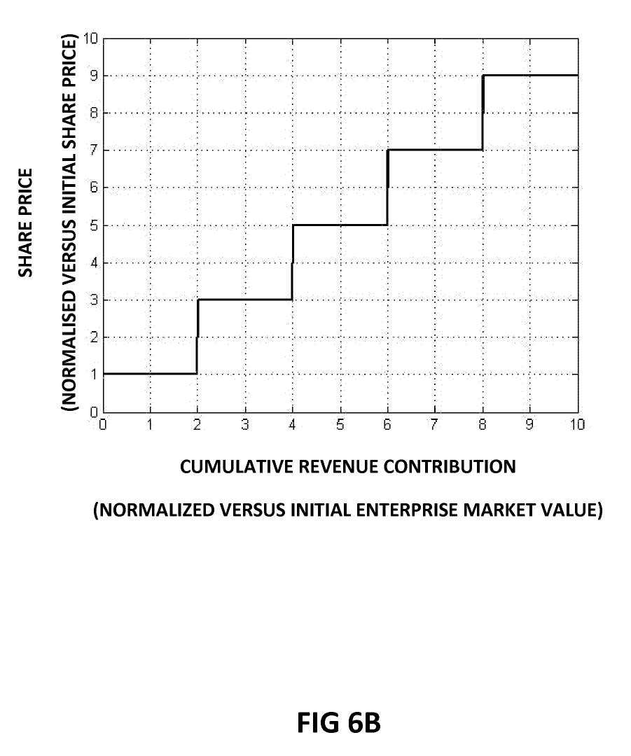

In the second exemplary embodiment of the “program” we might have:

$$\{ \begin{matrix}\begin{matrix}{f}_{2} ( {RC}_{i + 1} , {EMV}_{i} ) = {EMV}_{01} + {SP}_{01} ( {CSN}_{i} - {CSN}_{01} ) … \\ for {CRC}_{i + 1} < {C}_{1}\end{matrix} \\ \begin{matrix} = {EMV}_{02} + {SP}_{02} ( {CSN}_{i} - {CSN}_{02} ) … \\ for {CRC}_{i + 1} < {C}_{2} \\ … \\ \begin{matrix} = {EMV}_{ON} + {SP}_{ON} ( {CSN}_{i} - {CSN}_{ON} ) … \\ for {CRC}_{i + 1} < {C}_{N}\end{matrix}\end{matrix}\end{matrix} \qquad ( 9.2 )$$

wherein f₂ is another choice of function for f CRCᵢ₊₁ is the cumulative revenue up to the (i+1)th “revenue contribution event” and EMV₀₁, EMV₀₂, EMV_{0N} as well as SP₀₁, . . . SP_{0N}, CSN₀₁ . . . CSN_{0N}, C₁ . . . C_{N}, and N etc. are predetermined values using to build and design an stepwise enterprise market valuation function (see FIG. 2B and FIG. 6B). In this second exemplary case the share price increases in steps after each predetermined intervals of cumulative revenue (FIG. 6B) and therefore the enterprise market value also jumps in steps and then increasers linearly with the revenue at each intervals (FIG. 2B). Again depends on the nature of the business of the enterprise and profit margins of the goods or services of the enterprise one can adapt a set of reasonable and rational parameters to design the client incentive program function which can appreciate in value with the increase in the enterprise market value or with the growth and success of the enterprise.

In addition, lets, also for simplicity, define the function g in Eq. 2 as:

g(RCᵢ/SPᵢ)=RCᵢ/SPᵢ (10).

Obviously the choices for these functions (e.g. f and g), parameters and constants introduced in Eqs.1-8, Eq. 9.1, and Eq. 9.2 are endless making a wide range of client incentive programs available and different enterprises can choose different programs (i.e. different functions and parameters).

Referring to FIGS. 2A and 2B now, the graphs shows enterprise market value versus the normalized cumulative revenue contribution for the above two exemplary program embodiments with the selected functions (i.e. 2A is related to f₁ and 2B is related to f₂). The quantities are normalized versus the initial enterprise market value of the enterprise before starting to subscribe to the client incentive reward program. The initial enterprise market value, for instance, is either set by the original shareholder or it has been discovered though a prior investment or the public market.

Based on the adapted program (i.e. the choices of the function f and g), share price, share number, etc. the client's equity percentage change after each “revenue contributing event” can be subsequently calculated using the given formulation (i.e. Eq. 1 to Eq. 9). A computer executable program is made to perform the algorithm that employs and implement the formulas. The computer executable program performs the calculations necessary and allocates the share or stocks for the clients based on their revenue contribution amount, and further register, assigns, and update the records of the entitled stockholder according to the methods of this invention.

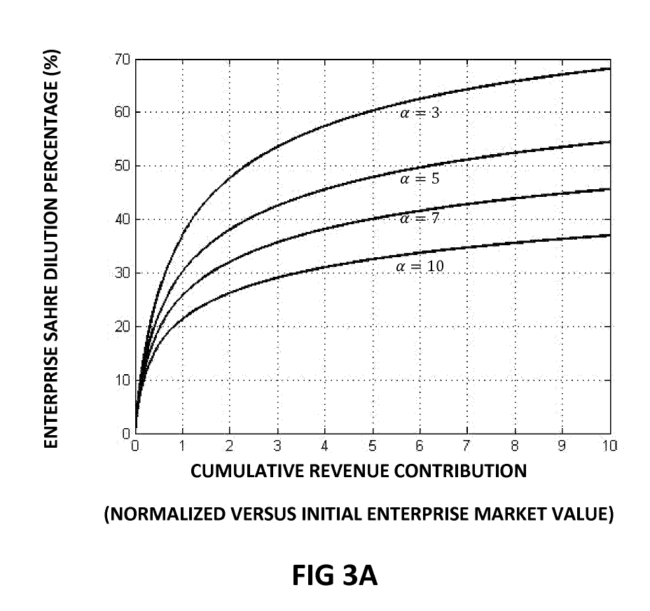

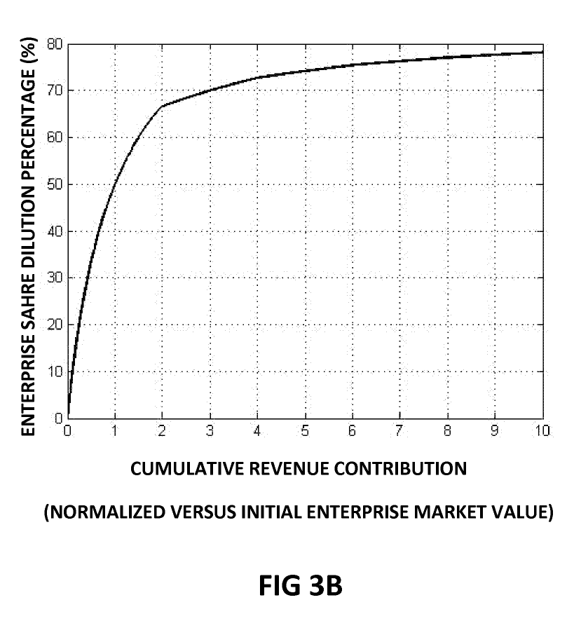

FIGS. 3A and 3B show respectively the enterprise share dilution in percentage as a function of normalized cumulative revenue contributions for f₁ and f₂, respectively. As seen in FIG. 3A the enterprise share dilution percentage can vary significantly with the parameter α as expected.

In depiction of these exemplary graphs and calculations we assumed equal revenue contributions for each event wherein the event is triggered after each 0.001 worth of the initial enterprise market value. The enterprise, obviously, have a choice to adapt various other policies such as calculating the share number for a client that has contributed multiple amount of “revenue contribution event” either as one single event or single change of state (FIG. 1) and calculate their allocated share in one step or a revenue contribution of multiple times of RCE be regarded, for instance, as several quantized consequent events.

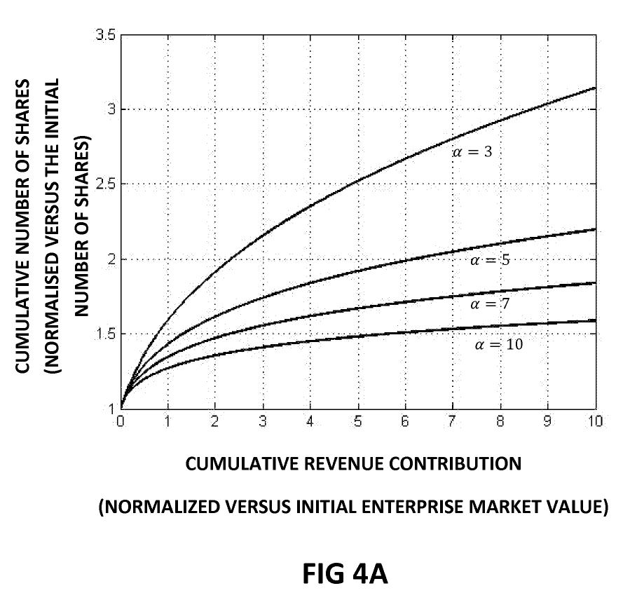

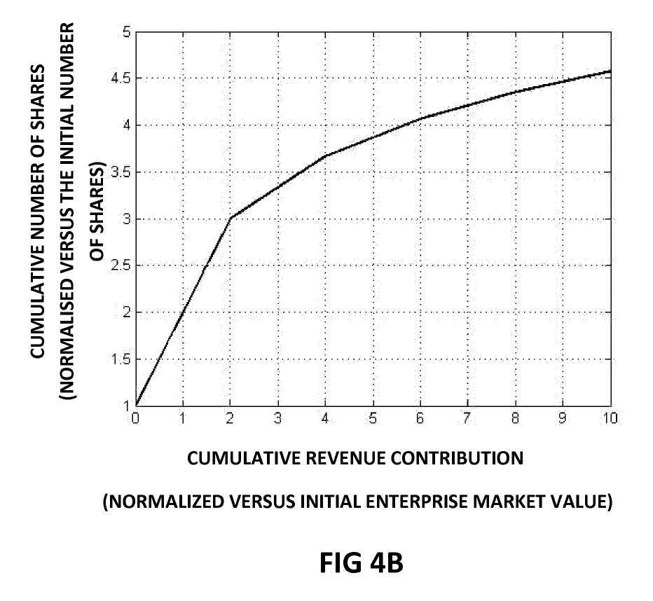

In FIGS. 4A and 4B, there are shown cumulative number of shares (normalized versus the initial number of shares) versus the cumulative revenue contribution. For instance it can be seen from FIG. 4A that for an enterprise that has adapted the f₁ function with an α=7 and the “revenue contribution steps of 0.001 (i.e. 0.1% of the initialEMV₀) the total number of share, after receiving revenue contribution of 10 times the initial value of the enterprise, has increased to almost 1.8 times of the initial number of share at the start of the program. However the total number of shares for the enterprise that has adapted the f₂ function (with share price steps of FIG. 6B) has increased to over 4.5 times of the initial number of shares at the start of the program.

Accordingly, the enterprise can know how much share they need to allocate for the programs depends on their predetermined objectives. The predetermined objectives can be their desirable dilution percentage, or their objective enterprise market value, or duration of their program or the desired cumulative revenue contributions etc.

Although in these exemplary cases we do not consider other parameters such as external investments or other ways that a company might increase or decrease its outstanding share or market value, other events (e.g. an equity financing or a share buyback etc.) can also be reflected in the program readily by those skilled in the art and still be able to employ the client incentive program according to the teachings of this invention. For instance the program can be defined or legally be structured in such a way that will allow the enterprise to manage the enterprise based on the decisions made by the authorities of the enterprise in the framework of good corporate governance and/or shareholders' interests.

Therefore the client incentive programs and the methods of this invention can be adapted without restriction in variety of situations and without limiting or restricting the usual operation of the business enteritis or the enterprises.

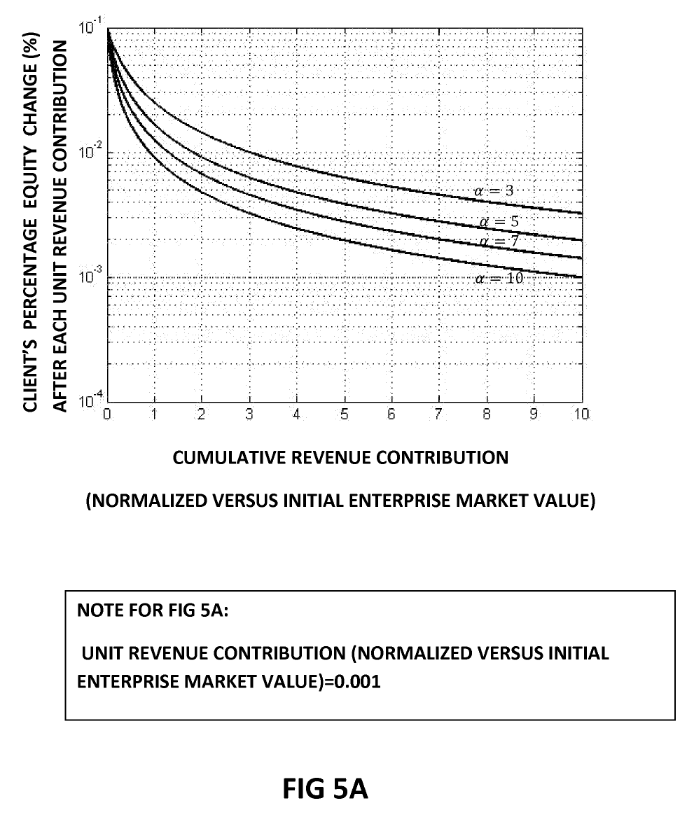

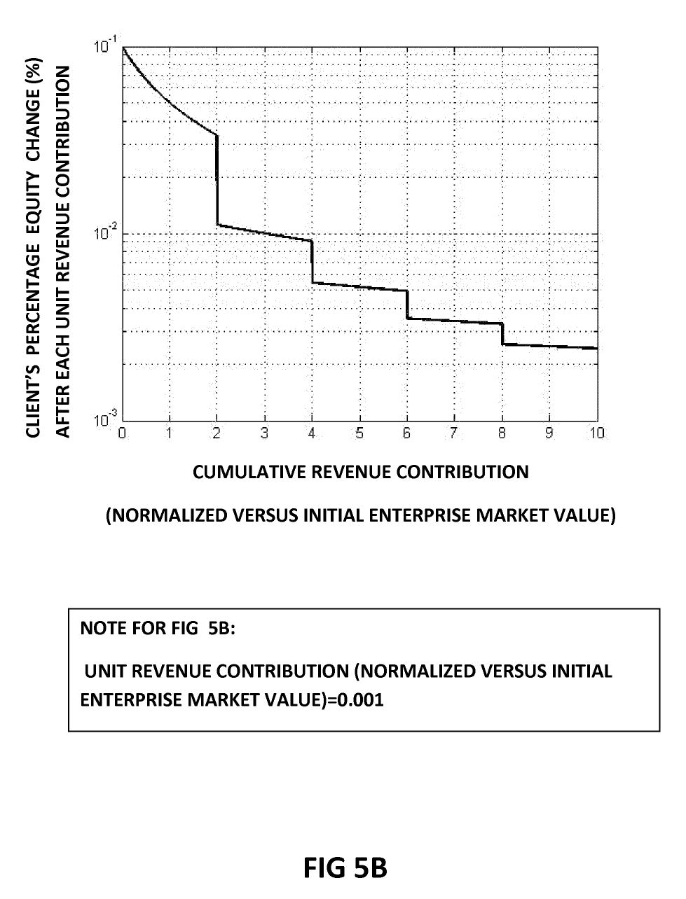

Referring to FIGS. 5A and 5B now, there are shown logarithmic plot for the expected client's equity percentage change after each unit of revenue contribution for the adapted program of f₁ and f₂ respectively. These figures basically show the percentage ownership for a client after contributing a unit revenue contribution versus the stage (or the sate) that the client triggers a “revenue contributing event”. In other words it shows how much of the enterprise equity would the client receive as a result of her/his/it's revenue contribution depending upon the stage of contribution. For instance the first client who contributed normalized revenue of 0.001 will receive about 0.1% equity while the later stage clients percentage equity will decreases since the enterprise market value of the enterprise has been increased at later stages. As is expected early clients will receive higher percentage of the enterprise which is one of the objective of the client incentive program according to the present invention.

The equity percentage of the early clients usually dilutes as a result of later clients entitlements to the equity but the enterprise market value appreciation will over compensate the percentage dilution. However, if desired, the program can be designed in such a way that the client initial percentage will not dilute over time.

In terms of marketing, since the clients become partly stockholders they will help to market the goods and services of the enterprises by word of mouth or any other instruments that they have, to promote the business of enterprise. The clients not only contribute to the enterprise revenue but also are encouraged to help to grow the enterprise faster and further. In this way enterprise with valuable goods or services can have access to a larger client based faster and therefore increase their chances of success significantly.

Moreover the clients will be more inclined to be a repeated client in order to accumulate more equity in that enterprise.

Referring to FIGS. 6A and 6B now, there are shown the normalized share prices of the enterprises as a function of the normalized cumulative revenue contribution for the adapted program of f₁ and f₂ respectively. In FIG. 6A it can be seen that share price appreciate with the increase of the cumulative revenue and as seen the share price increase is also proportional to the constant α so that the higher the α the sharper and faster the increase in the share price.

In FIG. 6B the share prices were set in different intervals as a stepwise function of the “normalized cumulative revenue contribution” and share price jumps at the end of each interval. This program or embodiment (i.e. the choice of f₂) is useful to encourage the clients to participate and make a revenue contributions before it reaches its threshold and jump to a higher level. This may cause a healthy competition and fast adaptation of the enterprise in the market since some clients may like to see a multiple jump in the value of their holdings.

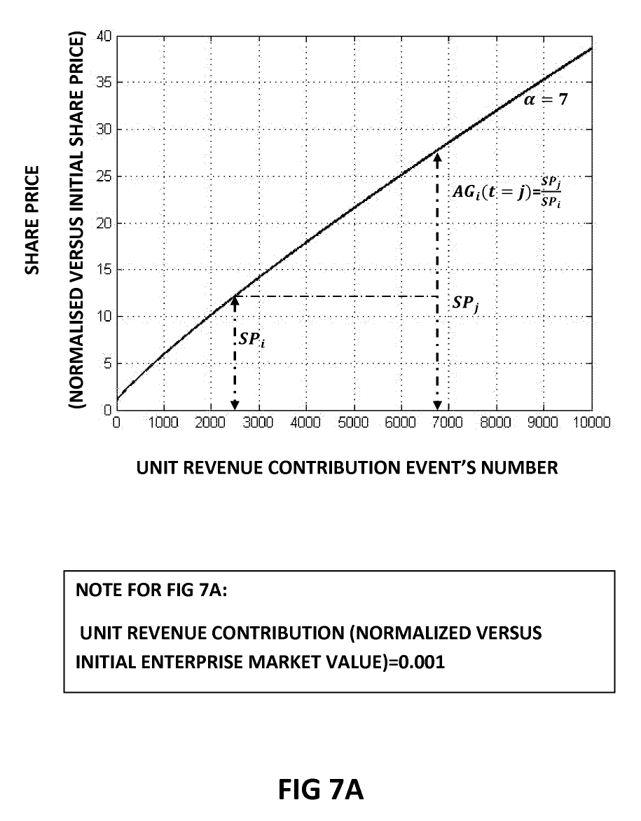

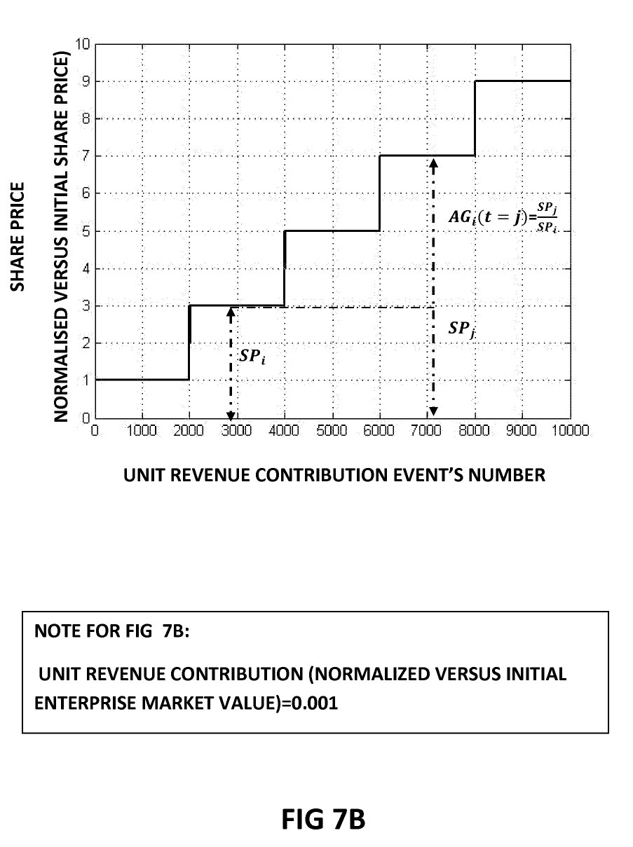

In FIGS. 7A and 7B, the share price appreciation for the clients is measured and quantified further by way of the ith client share price and the jth client share price (i.e. the appreciation gain in Eq. 7) for the adapted program of f₁ and f₂ respectively. A comparison between the appreciation gain of the two figures shows the result of the choices of program function (e.g. f₁ or f₂) for a client. Obviously the enterprise who has adapted the first program is advantageous over the enterprise who has adapted the second program given all other conditions such as the good and services are the same for both enterprise. Therefore by varying the parameters and adapting different programs, an enterprise can compete in the market place while the clients will also have a choice of preferring to do business with one company or another.

It is clearly shown that early clients can make multiple times the revenue that they have contributed to the enterprise after some times. Therefore they have not only used the goods and/or the services but they have had made multiple times over profit as a result of their business with the enterprise that have adapted or has implemented such a reward program. On the other hand the enterprise has achieved its objectives of fast growing and accessing to the cash flow through clients' revenue with acceptable level of dilution. This is a strong proposition both for a client and the enterprise. Therefore the methods given here can be instrumental in marketing good and services and accessing to the cash and financing a company or a venture.

For further illustration and as a quantified example, lets consider an enterprise with an initial value of EMV₀=$1 million, using a similar initial conditions to our calculations above an RCE event will be $1000 worth of revenue (could be set to much les amount). If we further assume an initial share number of 1 million or equivalently initial share price of $1; the enterprise with f₁ and α=7 will have about 1.8 million number of share, after achieving $10 million cumulative revenue (i.e. achieving the cumulative revenue of 10 times the initial enterprise market value) from the clients, whereas the share price has increased to $40 and the enterprise market value have increased to more than $70 million. The first client who has contributed $1,000 to the enterprise and had received almost 1,000 number of share will have a stock worth of $40,000 at the end of the program. At the same time the client number 2500 (see FIG. 7A) only get about 83 shares for a $1,000 revenue contribution, because the share price is about $12 at that stage (or state), which will be worth about $3,320 at the end of the program. Also seen from FIG. 7A, the client number 2500 has almost 2.25 times appreciation at the state (or the time) that the client number 6800 triggers an RCE.

The allocated share can be put in legal and financial instruments such as share escrow, pool of shares, option pools, treasury share or any other legal vehicle that is lawful and can be structured legally. One might call these instruments a “reward vehicle”. In this way the enterprise or a vendor who wants to adapt a program can calculate the amount of stock or the maximum probable number of needed shares or stock of the enterprise, coupons, or any other valuable reward in advance in order to achieve its sales, marketing and financing objectives.

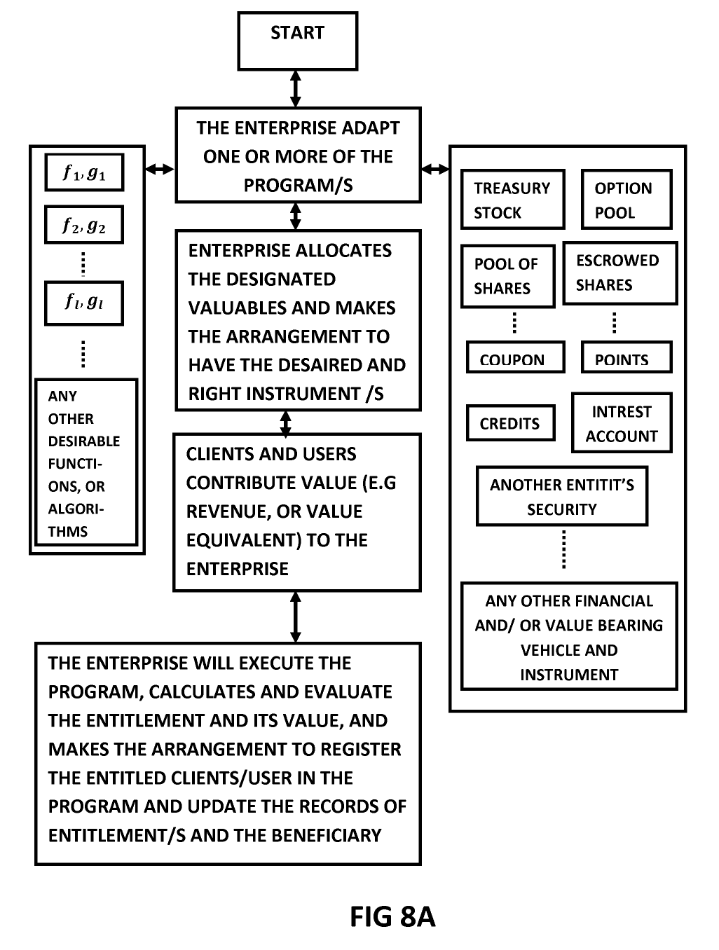

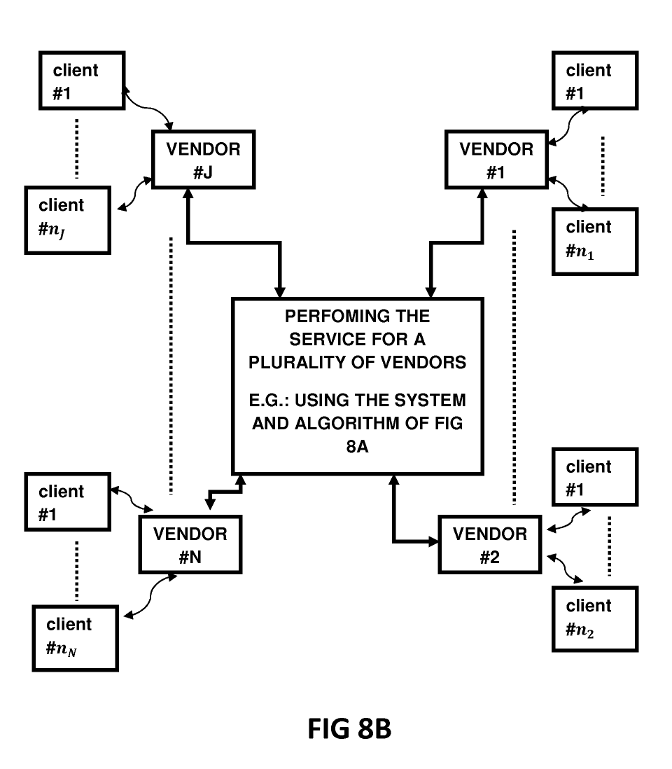

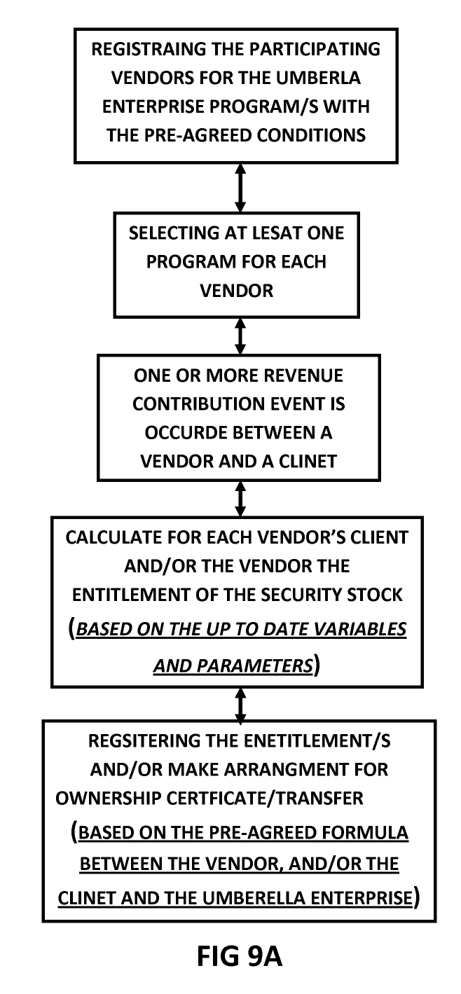

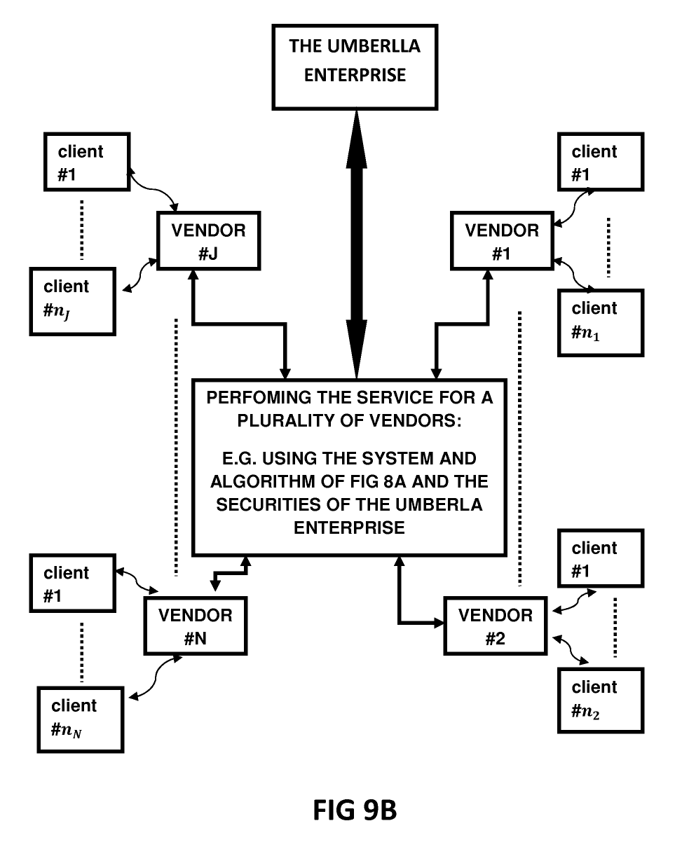

Referring to FIG. 8A now, it shows one exemplary embodiment of the flowchart and step of implementations of the method/s disclosed in the present invention. As seen the enterprise select or chose a “reward vehicle” and also chose the program functions (e.g f and/or g) then the enterprise can implement the program for revenue contributing clients as explained in the chart boxes. The system and method of FIG. 8A can be implemented individually by one or more enterprise to configure the entitlement and assigns the stocks for their clients.

In FIG. 8B, however, there is shown a system that can perform such a service of stock allocation and client incentive programs for variety of enterprise who want to subscribe to the program with their own choices of functions (e.g. the function f) and the system of FIG. 8B automatically will perform the method for the subscribed enterprises. Accordingly, FIG. 8B indicate a more centralized system that will perform the method as a service for one or more subscribed or participating enterprises.

In FIG. 8B, the system might be regarded as the aggregator of the service or a holding company that has aggregated several small businesses such as sole-proprietorships, partnership, etc to perform the service for them and provide an “Umbrella Enterprise” (UE) whose stock can be used as a way of promoting each individual business products etc.

Therefore, in FIG. 9A there is shown a flowchart of a method wherein a plurality of vendors (e.g. small business, retailers, clusters of a businesses etc.) can participate in the program/s without having to perform the program individually. In this embodiment one or more vendors participate in an umbrella enterprise whose securities or reward program is to be used commonly by the participating vendors. The clients of participating vendors get the reward based on per-arranged or pre-agreed formula between the vendors and the umbrella enterprise. In this embodiment the reward can be given both to the client and the vendor based on pre-agreed terms. For instance, if a client of vendor 1 has contributed x amount of revenue to vendor 1, the umbrella enterprise calculates the share entitlements for that revenue contribution and therefore allocated certain ratio of that entitlement to the client and certain amount to the vendor itself. The umbrella enterprise may charge the vendor a commission or a percentage of their sale and/or also do the marketing for the participating vendors and promoting their products and make a profit for itself by charging a service fee, commission, consulting fee, etc. Again all the parameters and variable needed for the calculation can be assigned for the umbrella enterprise's security and market value. The value of the umbrella enterprise is originated; for example, from the revenue that it can generate through direct commissioning/charging for performing the service for its participating vendors and/or the commission charged for each revenue generating event of each of participating vendors.

In one exemplary embodiment for umbrella enterprise, participating vendors will allocate certain percentage or ratio of their revenue for the UE and in return the vendors and their clients will enjoy the service for the program and become stockholder of the UE based on their revenue contribution to the UE (same as for single enterprise i.e. Eq. 1:-10). Therefore the there could be revenue sharing arrangement between the vendors and the UE and yet the vendors and their clients be rewarded equity in the UE. Therefore other arrangements can be made in conjunction or parallel to the program without limiting its main purpose of rewarding revenue generating parties in the form of equity of an enterprise.

Referring FIG. 9B now, it shows the umbrella enterprise system in more details and graphics. As seen the UE (Umbrella Enterprise) has a system to update its security distribution and ownership for a plurality of vendors and their clients. As the market value of UE increases, as a result of operation, so is the appreciation gain of the client and/or the vendors who are the stockholders of the UE. In this way vendors tend to amplify each other's sales in order to have a common appreciation and gain. Clusters of corporations and business will form this way and can boost the competition even higher in the forms of clusters of businesses for different industries.

For instance a company and its suppliers can form an UE and employ the methods, algorithms and systems of the present invention to amplify each other success since they have more common interests to win in the market and being loyal to each other. Making higher revenue (and of course profit) for each participating vendor means higher market value for their UE.

The systems of FIGS. 8-9 can perform the real time stock entitlement for each client and the corresponding vendor and therefore it perform a dynamic and up to the minute reflection of the enterprise state and the stockholders. The system will perform the stock allocation and entitlements based on the formulations and the algorithms of present invention and provide an incentive for clients to purchase and contribute revenue or contribute value to a venture as early as possible in the life of an enterprise and help to grow a valuable venture in rapid and healthy manner. The risk of being an early adapter of product or service of a new enterprise will be balanced by the handsome appreciation of the stock value of that enterprise.

Such a system and method might, therefore, be implemented in the computer executable and computer readable instruction environment. Therefore, in another aspect of the invention, there is provided computer software program that uses the algorithms and method and formulations of the present invention to perform such a service for one or more of the enterprises or for a group of vendors as shown in FIG. 8A to FIG. 12.

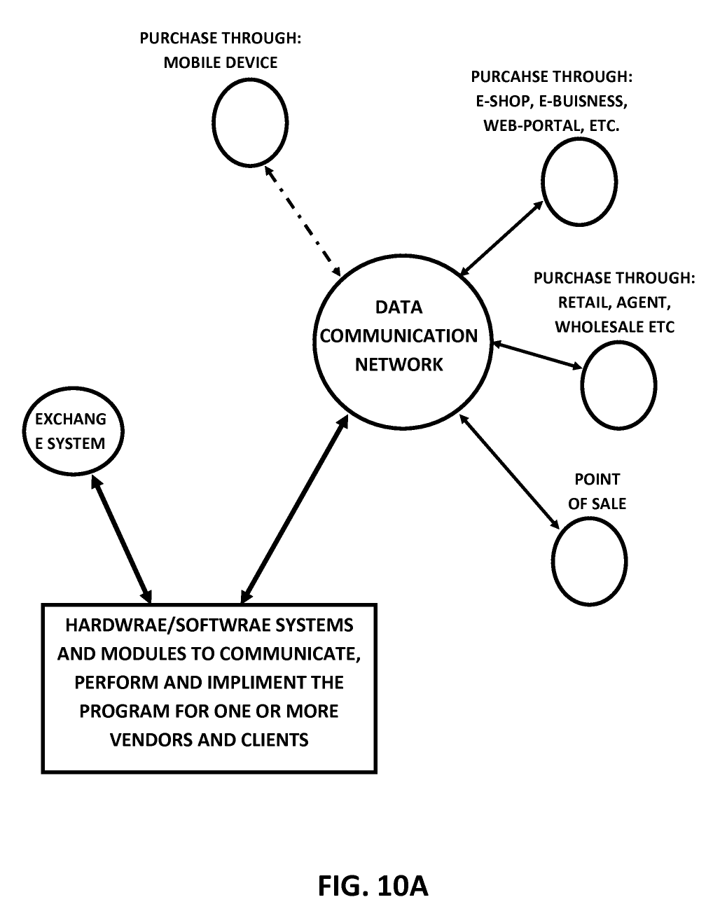

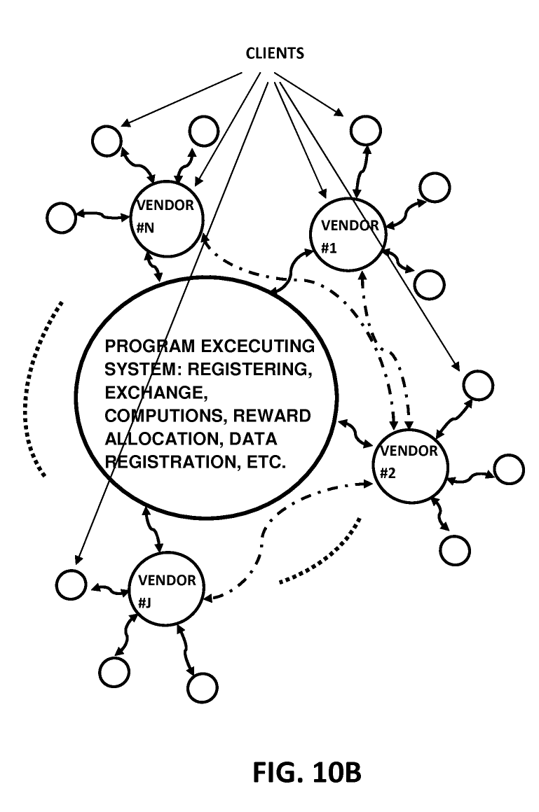

Referring to FIG. 10A, as shown in FIG. 10A, such a system and method use a computing system environment having communication ports and means to be connected to the communication network or computer network to obtain the information of each revenue contribution event and perform the calculation and assign the right entitlements to the beneficiaries of the revenue or value contributor to the enterprise. Such a computer system will have at least one processing unit and at least one storage medium. The system also contains the information data of all the entities involved. Such data can include, for instance: the enterprise name, time of the revenue/value contribution, name and the contributor's information, the beneficiaries' information, the enterprise market value versus time, the vendors' name, the particular of the adapted program for each vendor and client etc.

Accordingly, as seen in FIG. 10A, there is provided a system that is enabled to receive the data respective of any revenue generating transactions between a client and a vendor through variety of ports such as point of sale, websites, mobile devices and web-shops enable of initiating and/or completing a transaction between a client and at least one of the participating vendors. The point of sale may include a sales representative, retail store, agent, etc. The data can be sent or being communicated with the system through private networks or through internet, fax, telephone line or wireless communication devices and apparatuses such as satellites, mobile phones, portable computers and the like. These sale ports send the desired data respective of a revenue generating event to the system through one or more data communication network/s. The system is composed of hardware such as processing units and storage media, data network interface/s, and software or software modules for obtaining and processing data, performing the method and algorithm of the present invention by having computer codes executable by at least one computer system embedded on a suitable storage medium.

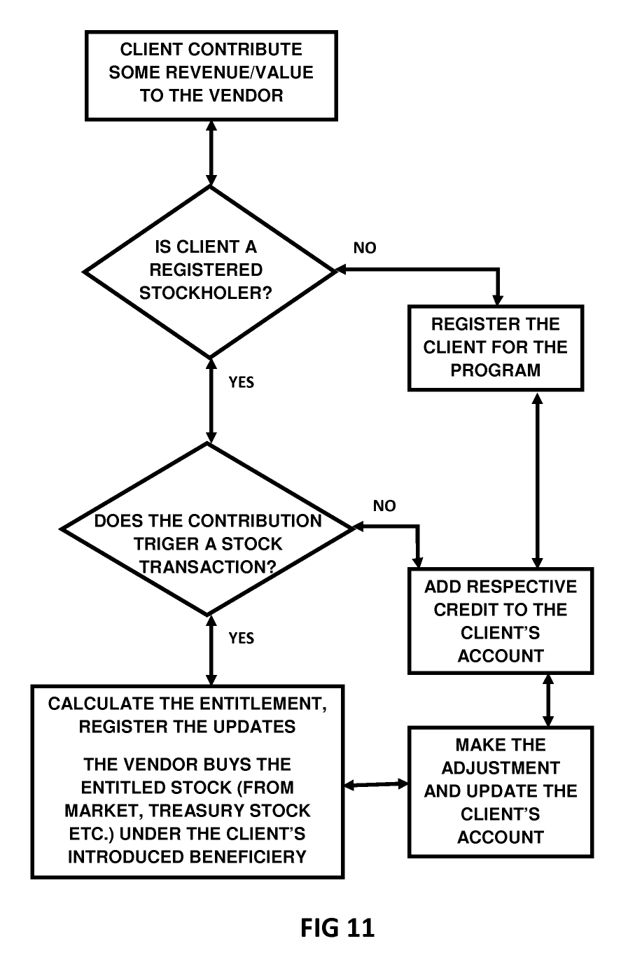

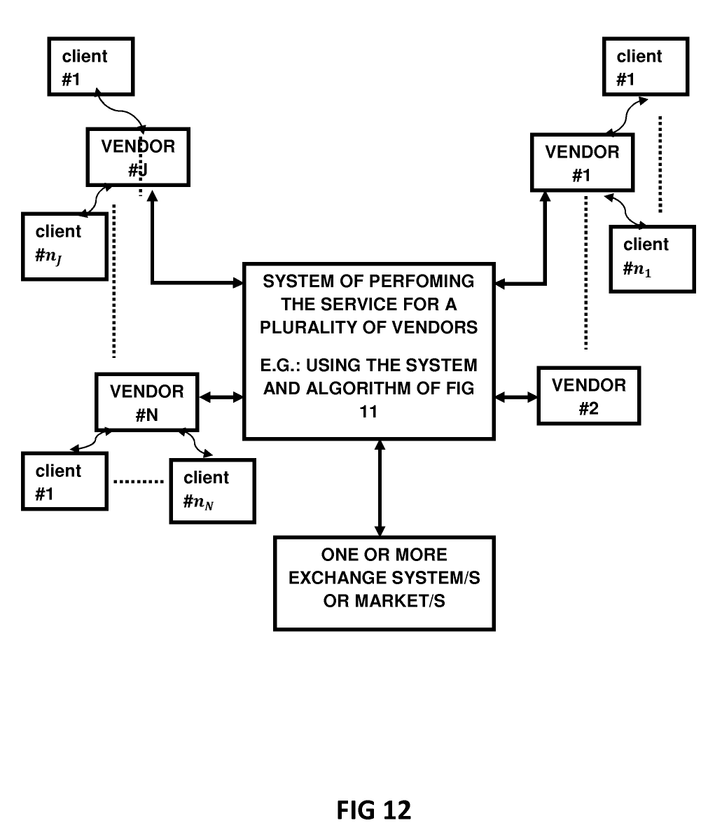

The system of FIG. 10A is also connected to, or has access to, or containing the information of an exchange system in which the stocks of publically trading enterprise are traded. This is for the cases that one or more of the participating vendors are publicly trading entities whose stock value is determined by the open market. The system of FIG. 10A therefore can readily be adapted by public enterprises as it will be explained in the description of FIGS. 11 and 12 in more details.

Referring to FIG. 10B here, it shows the network effect of such system/s and method/s, in the general economical scene. Enterprise, companies and individuals will become stockholder of each other and the system will provide a real time stock entitlement for all participating parties such as the vendors and their clients and business to business clients and supplier etc. Such a business and financial network can be shown to be more robust against the fluctuations and volatilities of the market.

Referring to FIGS. 11 and 12 now, wherein there are shown systems that refer more to the publically traded enterprises since usually a stock is more valuable and favorable when is liquid and it can easily been transferred or exchanged or being cashed out. Therefore when the client stock “program” is tied to a public enterprise the program might be more effective.

Moreover, obviously and ultimately the market will determine the market value of an enterprise and therefore these methods should and can be adapted further to have enterprise market value that is determined, for instance, by a public market.

In FIG. 11, there is shown a method and algorithm for enterprises to purchase or award stock of an enterprise according to another exemplary embodiment of this invention. In this system and method embodiment, the enterprise or a vendor can buy the client's reward stock/share from a public market under which its own share been listed either directly from a seller of the stock or from its own treasury stock, or a costumer reward program pool, stock basket, etc.

In this case the stock/share price for the (i+1)th client can still be calculated using the Eq. 1-7 except that in Eq. 1, the initial EMV is determined by the market (or equally the share price before the revenue contribution event, RCE). So if the market value of the enterprise (i.e. the market capitalization) is EMVᵢ before the (i+1)th revenue contribution event, the enterprise value at (i+1), ie. EMVᵢ₊₁ state still can be calculated from Eq. 1, and the share price for the (i+1)th is:

$${SP}_{i + 1} = \frac{{EMV}_{i + 1}}{{CSN}_{i}} = \frac{{EMV}_{i + 1}}{{EMV}_{i} / {SP}_{i}} , … i = 0 , 1 , 2 , 3 … \qquad ( 11 )$$

wherein again CSNᵢ is the total number of shares outstanding which can be obtained by dividing the enterprise market capitalization by the share price that are obtained from the market (e.g. the bid or the ask price in the exchange system) and the number of entitled share can still be given and calculated by Eq. 2. The enterprise therefore will buy SNᵢ₊₁=g(RCᵢ₊₁/SPᵢ₊₁) for the client who has contributed RCᵢ₊₁ amount of revenue where g is a predetermined or preselected function.

Having fund out the enterprise market value and/or the market share price, the participating enterprise can buy the entitled stock for its revenue contributing client either from the market or from a treasury stock or any other legal and financial vehicle desired and available.

Therefore, effectively sale of a product or service is regarded as a stock transaction. In this way when the enterprise is listed in the public market the effect of any sales or revenue generated by the company can immediately be reflected on the price of the stock by the exchange system. For instance this will happen automatically when the enterprise buys the stock from the market. The market still can and would have its own usual course of fluctuations and volatilities while incorporating the effect of adapting and executing the “program” by the enterprise.

The participating vendor can chose its own stock awarding program based on its objectives and goals. Moreover the enterprise can select the parameters and the functions (e.g. f and g function in Eq. 1, 2 or Eq. 9.1, 9.2 or duration etc.) for the program in such a way that it would not be very attractive for the client to go on and sell the newly earned stock back to the public market. Furthermore the vendor may elect to introduce some restrictions on the resale of such awarded stock (e.g. imposing a locked-up period etc.).

The system of FIG. 11 can also work for private enterprises in terms of registering the client to become a stock holder and calculate the stock entitlement at the time of revenue generating event based on the disclosed methods of FIG. 8A and systems of FIGS. 9 and 10. The allocated stock then is to be used, for instance, in future if the company goes public or be purchased back in cash in the future by the private or public enterprise.

Referring to FIG. 12 now, it shows a system that uses the methods and algorithms disclosed in this invention to perform the service/s for a plurality of vendors interested in participating in the client stock holding “program”. Each vendor can have its own set of parameters of the exemplary formulation given above to adjust its own program to its client. The system of FIG. 12 will then perform such service (e.g. the stock entitlements and transactions) for the vendors. The vendors therefore subscribe to such service from the system of FIG. 12 and participate in the program to promote and reward their costumer.

For those companies that are listed in public markets, this can be done fairly straightforward using the existing exchange market and their electronic exchange system and broker. However the system of FIG. 10A also enable to do the service for publicly listed enterprises.

Moreover such a system and service can be used by brokers in order to get more clients registered. Therefore a broker can also participate in the program to add the benefit to the client (the broker is also entitled to participate to such a program to reward its client or be rewarded as a client).

Furthermore, it is fairly straightforward to further provide, for instance, an online platform so that the clients can check and see the number or the value of their rewarded stock in the enterprise for which that they have made revenue contribution.

In conclusion the methods, systems, algorithms, formulations and programs of the present invention provide an effective method of marketing and financing enterprise/s and increase its revenue more rapidly and increase the rate of growth and chances of success for the enterprises adapting one or more of the disclosed “programs”. The clients, especially early adaptors, benefit greatly by not only consuming the product or using the service but also by potentially earning multiple returns on their revenue contribution to the enterprise that has adapted one or more of the “programs”. The systems of this invention disclose the tools and vehicle to implement the algorithms and implement the method/s in detail.

It is apparent to those skilled in the art that such disclosed systems and methods can be executed and implemented in many different ways and configurations and topologies. For example, one or more of the functions can be executed or performed by different processing units in different locations, or in general be scattered around the globe.

A provider of such services, a promoter or a business associate, and/or the vendor facilitating the exchange of data over the data communications networks are considered as the integrator of the disclosed systems and methods. Therefore from this disclosure point of view the system can topologically being summarized in a system (even as simple as a router) that facilitate the exchange of data between the users and at least one of the various parts of the system/s of this invention regardless of the physical locations of the hardware and the associated operations and apparatuses, e.g. site hosting, servers, data storages, computational engines, marketing, accounting, engineering, etc.

Additionally those familiar with the art can yet envision and use the method and system for and in different embodiments and applications. It is understood that the preferred or exemplary embodiments and examples described herein are given to illustrate the principles of the invention and should not be construed as limiting its scope. Various modifications to the specific embodiments could be introduced by those skilled in the art without departing from the scope and spirit of the invention as set forth in the following claims.

1. A method of marketing and financing wherein a revenue contributing client of an enterprise is rewarded wherein the reward is a function of enterprise market value and revenue contribution of the client when a revenue contribution event is triggered.

2. The method of claim 1, wherein the revenue contribution event is triggered when the client makes a contact with the enterprise.

3. The method of claim 1, wherein the revenue contribution event is triggered when the client makes payment to the enterprise respective of the revenue contribution.

4. The method of claim 1, wherein the reward is selected from one or more of the following list:
a. stock of one or more private enterprise,
b. stock of a one or more publicly trading enterprise,
c. stock of a third party enterprise,
d. treasury shares of one or more enterprise,
e. pool of share of one or more enterprise,
f. stock option pool of one or more enterprise,
g. escrowed shares of one or more enterprise,
h. coupon,
i. points,
j. interest bearing credit,
k. monetary valuable points.

5. The method of claim 1, wherein the clients revenue contribution is a function of client's value contribution.

6. The method of claim 1, wherein the reward has one or more tradability restrictions wherein one of the possible restrictions is time limit for restriction on tradability.

7. A computer storage medium having embodied thereon computer executable instructions to perform a method of assigning a certain number of stocks of an enterprise to a client by executing computer executable instructions which calculates the stock entitlement as function of the client's revenue contribution and value of the enterprise at the time of revenue contribution event.

8. The computer executable instructions of claim 7 further comprising a computer implementable algorithm to calculate the amount of allocated enterprise stock for a predefined client incentive program based on a predetermined set of parameters and functions of such parameters of a client incentive program and/or based on the projected revenue contribution, stock dilution objectives, and the program time interval.

9. The computer executable instruction of claim 7 further comprising one or more assigning program with predefined parameters and one or more functions for calculating the assignment of the stock reward to the clients.

10. The computer implementable algorithm of claim 8, wherein the algorithm is implemented using one or more computer systems.

11. A method of financing and marketing of plurality of enterprises comprising:
a. an umbrella enterprise,
b. one or more client incentive program,
c. assigning a certain amount of stock of the umbrella enterprise to at least one revenue generating client of at least one of said plurality of the enterprises based on at least one of said incentive program.

12. The method of claim 11 wherein at least one enterprise, from a set of said plurality of enterprises and the umbrella enterprise, is a publicly trading business entity.

13. The method of claim 11, wherein said umbrella enterprise also have at least one incentive program to reward its own revenue contributing clients.

14. A system of assigning a number of stock of an enterprise to a client comprising:
a. a module for corresponding an enterprise to at least one client reward program,
b. one or more storage medium for storing at least the client's introduced beneficiary account information,
c. a data interface to obtain data indicative of at least the client's information and a revenue contributing event,
d. a computer storage medium having computer executable instructions for performing an algorithm and method that when executed by the computer system cause the computer system to do:
i. registering a client if the client is not already registered as a stock holder,
ii. calculating the stock entitlement of the client as a function of the client's revenue contribution and market value of the enterprise,
iii. updating the client's introduced beneficiary account.

15. The system of claim 14 wherein the system is comprised of one or more computer systems.

16. The system of claim 14 wherein the system is connected to one or more exchange system.

17. The system of claim 14 wherein the enterprise market value is obtained from an exchange system.

18. The system of claim 14, further configured to facilitate access to an online facility wherein the clients can obtain information about the number or the value of their rewarded stock in the enterprise for which that they have made revenue contribution.

19. The system of claim 14 further comprising:
a. providing one or more incentive programs,
b. providing a module for registration and account creation for one or more participating enterprise,
c. assigning at least one incentive program to at least one of said one or more participating program,
d. providing a module for calculating the stock allocation for clients of said one or more participating enterprises based on one or more incentive programs.
